(19) United States
(12) Patent Application Publication
(10) Pub. No.: US 2014/0278811 A1
(43) Pub. Date: Sep. 18, 2014

(54) SALES AND MARKETING SUPPORT APPLICATIONS FOR GENERATING AND DISPLAYING BUSINESS INTELLIGENCE

(71) Applicant: SALESIFY, INC., Redwood City, CA (US)

(72) Inventor: Oliver Deng, Redwood City, CA (US)

(73) Assignee: SALESIFY, INC., Redwood City, CA (US)

(21) Appl. No.: 13/801,485

(22) Filed: Mar. 13, 2013

(51) Int. Cl. G06Q 10/06

(52) U.S. Cl. CPC G06Q 10/0637
USPC 705/7.36

(57) ABSTRACT

Disclosed are media, systems, and methods for creating business intelligence (BI) applications. The BI applications display competitive intelligence (CI) including actionable contact information for individual sales targets associated with a business entity that utilizes particular enterprise.

### BACKGROUND OF THE INVENTION

Business intelligence (BI) is the ability of an organization to collect, maintain, and organize data. The goal of modern business intelligence deployments is to support better business decision-making. Mined properly BI can help businesses develop new opportunities. Competitive intelligence (CI) is a subset of BI. BI uses technologies, processes, and applications to analyze mostly internal, structured data and business processes while competitive intelligence gathers, analyzes and disseminates information with a topical focus on company competitors.

### SUMMARY OF THE INVENTION

A key type of BI and CI is qualified sales leads that include contact information for key decision makers. Businesses need to market and sell to their target accounts in the face of high turnover, which causes contact information to become stale. Even in a stable economy business to business (B2B) contact information typically grows stale at a rate of 2% per month. Current BI solutions are plagued by low quality, unverified BI and CI, which often includes contact information that is not actionable and leads sales forces to pursue unqualified prospects. Moreover, existing BI solutions fail to adequately associate contact information with specific products in a product category and fail to transform raw data into actionable CI such as market share and market opportunity for those products and product categories.

There exists a long-felt and unmet need for a BI system that offers up to date contact information and provides detailed competitive analysis for specific products in product categories. Advantages of the platforms, systems, media, and methods described herein include, but are not limited to, continuous harvesting of fresh data pertaining to specific products in their product categories wherein the data is matched to particular business entities and includes actionable, up to date, contact information. Additional advantages include a transforming freshly harvested date into a graphic display of actionable CI such as market share and market opportunity for products in a product category. The result is improved utilization and productivity of field sales resources.

In one aspect, disclosed herein are non-transitory computer-readable storage media encoded with a computer program including instructions executable by a processor to create a business intelligence application comprising: a software module configured to harvest data pertaining to products in a product category from one or more publicly available online resources; a software module configured to match the data to a business entity, the business entity an end user of at least one product in the product category; and a software module configured to transform the data into a business intelligence display, the display comprising: sales targets for a product in the product category, market share for a product in the product category, or market opportunity for a product in the product category.

In another aspect, disclosed herein are non-transitory computer-readable storage media encoded with a computer program including instructions executable by a processor to create a business intelligence application comprising: a software module configured to receive input indicating a product category, a product, and optionally, one or more additional sales parameters; a software module configured to harvest data pertaining to products in the product category from one or more publicly available online resources; a software module configured to perform keyword analysis on the data; a software module configured to match the data to a business entity, the business entity an end user of at least one product in the product category; and a software module configured to transform the data into a business intelligence display, the display comprising: sales targets for the product in the product category, market share for the product in the product category, or market opportunity for the product in the product category. In some embodiments, the one or more additional sales parameters comprise: industry, target size, target region, target revenue, or target current product. In some embodiments, the data is harvested from about 2 to about 20 publicly available online resources. In some embodiments, the one or more publicly available online resources comprise: a web search result, a technology discussion board, a technology user forum, a company web site, a job web site, a social network, or a professional network. In some embodiments, the software module configured to harvest data utilizes an automated software agent or a web bot to harvest data. In some embodiments, the keyword analysis comprises identifying keywords and determining word proximity associations. In some embodiments, the application further comprises a software module configured to perform validation of the data. In further embodiments, the validation is performed automatically. In further embodiments, the validation is performed manually. In some embodiments, the application further comprises a software module configured to filter the data to exclude data not associated with an end user of at least one product in the product category. In some embodiments, the sales targets comprise individual contact information. In some embodiments, the sales targets are searchable or filterable by one or more of: industry, technology, company, company location, ranking, company size, and contact. In some embodiments, the business intelligence display comprises a visual representation of market share or market opportunity in a product category. In some embodiments, the application executes over time and stores data to produce a trended business intelligence display. In some embodiments, the application is in communication with a media portal, the media portal offering product information for download, the media portal capturing and communicating individual contact information.

In another aspect, disclosed herein are computer-implemented systems comprising: a digital processing device comprising an operating system configured to perform executable instructions and a memory device; a computer program including instructions executable by the digital processing device to create a business intelligence application comprising: a software module configured to harvest data pertaining to products in a product category from one or more publicly available online resources; a software module configured to match the data to a business entity, the business entity an end user of at least one product in the product category; and a software module configured to transform the data into a business intelligence display, the display comprising: sales targets for a product in the product category, market share for a product in the product category, or market opportunity for a product in the product category.

In another aspect, disclosed herein are computer-implemented systems comprising: a digital processing device comprising an operating system configured to perform executable instructions and a memory device; a computer program including instructions executable by the digital processing device to create a business intelligence application comprising: a software module configured to receive input indicating a product category, a product, and optionally, one or more additional sales parameters; a software module configured to harvest data pertaining to products in the product category from one or more publicly available online resources; a software module configured to perform keyword analysis on the data; a software module configured to match the data to a business entity, the business entity an end user of at least one product in the product category; and a software module configured to transform the data into a business intelligence display, the display comprising: sales targets for the product in the product category, market share for the product in the product category, or market opportunity for the product in the product category. In some embodiments, the one or more additional sales parameters comprise: industry, target size, target region, target revenue, or target current product. In some embodiments, the data is harvested from about 2 to about 20 publicly available online resources. In some embodiments, the one or more publicly available online resources comprise: a web search result, a technology discussion board, a technology user forum, a company web site, a job web site, a social network, or a professional network. In some embodiments, the software module configured to harvest data utilizes an automated software agent or a web bot to harvest data. In some embodiments, the keyword analysis comprises identifying keywords and determining word proximity associations. In some embodiments, the application further comprises a software module configured to perform validation of the data. In further embodiments, the validation is performed automatically. In further embodiments, the validation is performed manually. In some embodiments, the application further comprises a software module configured to filter the data to exclude data not associated with an end user of at least one product in the product category. In some embodiments, the sales targets comprise individual contact information. In some embodiments, the sales targets are searchable or filterable by one or more of: industry, technology, company, company location, ranking, company size, and contact. In some embodiments, the business intelligence display comprises a visual representation of market share or market opportunity in a product category. In some embodiments, the application executes over time and stores data to produce a trended business intelligence display. In some embodiments, the application is in communication with a media portal, the media portal offering product information for download, the media portal capturing and communicating individual contact information.

In another aspect, disclosed herein are computer-implemented methods comprising the steps of: harvesting, by a computer processor, data pertaining to one or more products in a product category from one or more publicly available online resources; performing, by the computer processor, keyword analysis on the data; matching, by the computer processor, the data to a business entity, the business entity an end user of at least one product in the product category; and transforming, by the computer processor, the data into a business intelligence display, the display comprising: sales targets for the product in the product category, market share for the product in the product category, or market opportunity for the product in the product category. In some embodiments, the data is harvested from about 2 to about 20 publicly available online resources. In some embodiments, the one or more publicly available online resources comprise: a web search result, a technology discussion board, a technology user forum, a company web site, a job web site, a social network, or a professional network. In some embodiments, harvesting data is performed by an automated software agent or a web bot. In some embodiments, the keyword analysis comprises identifying keywords and determining word proximity associations. In some embodiments, the method further comprises the step of performing validation of the data by the computer processor. In further embodiments, the validation is performed automatically. In further embodiments, the validation is performed manually. In some embodiments, the method further comprises the step of filtering the data, by the computer processor, to exclude data not associated with an end user of at least one product in the product category. In some embodiments, the sales targets comprise individual contact information. In some embodiments, the business intelligence display comprises a visual representation of market share or market opportunity in a product category. In some embodiments, the method is performed iteratively over time and the data stored to produce a trended business intelligence display.

In another aspect, disclosed herein are computer-implemented methods comprising the steps of: harvesting data pertaining to one or more products in a product category from one or more publicly available online resources, the harvesting performed by a computer processor configured to perform data scraping; performing, by the computer processor, keyword analysis on the data; matching, by the computer processor, the data to a business entity, the business entity an end user of at least one product in the product category; and filtering the data, by the computer processor, to exclude data not associated with an end user of at least one product in the product category; whereby the method produces sales target contact information, the sales target associated with a business entity that is an end user of at least one product in the product category. In some embodiments, the data is harvested from about 2 to about 20 publicly available online resources. In some embodiments, the one or more publicly available online resources comprise: a web search result, a technology discussion board, a technology user forum, a company web site, a job web site, a social network, or a professional network. In some embodiments, the keyword analysis comprises identifying keywords and determining word proximity associations. In some embodiments, the method further comprises the step of performing validation of the data by the computer processor. In further embodiments, the validation is performed automatically. In further embodiments, the validation is performed manually.

### BRIEF DESCRIPTION OF THE DRAWINGS

FIG. 1 shows a non-limiting example of a business intelligence display; in this case, a display of business intelligence for a product in a product category including market share, number of technologies and contacts per region, number of companies per region, and technology growth over time.

FIG. 2 shows a non-limiting example of a market share pie chart from the display of FIG. 1; in this case, a pie chart including detailed information available upon interaction with each element of the chart.

FIG. 3 shows a non-limiting example of a technology and contacts by region bar graph from the display of FIG. 1; in this case, a bar graph including detailed information available upon interaction with each element of the graph.

FIG. 4 shows a non-limiting example of a technology growth line graph from the display of FIG. 1; in this case, a line graph including detailed information available upon interaction with each element of the graph.

FIG. 5 shows another non-limiting example of a business intelligence display; in this case, a display of trended business intelligence for a product in a product category including market share, trends of competitor products over time, market share per industry over time, and market share per region over time.

FIG. 6 shows another non-limiting example of a business intelligence display; in this case, a display of trended business intelligence for competitor products in a product category including filters based on time, technology, and competitor dimensions (e.g., region, revenue, industry, and number of employees).

FIG. 7 shows a non-limiting example of an interface for searching and filtering business intelligence data; in this case, an interface for searching by technology name and filtering based on technology parameters such as: technology type, company location, specialized rankings, company size, and industry.

FIG. 8 shows a non-limiting example of the interface for searching and filtering technology business intelligence data of FIG. 7; in this case, an interface offering detailed technology type data filters.

FIG. 9 shows a non-limiting example of the interface for searching and filtering technology business intelligence data of FIG. 7; in this case, an interface offering detailed company location data filters.

FIG. 10 shows a non-limiting example of the interface for searching and filtering technology business intelligence data of FIG. 7; in this case, an interface offering detailed specialized ranking data filters.

FIG. 11 shows a non-limiting example of the interface for searching and filtering technology business intelligence data of FIG. 7; in this case, an interface offering detailed company size data filters.

FIG. 12 shows a non-limiting example of the interface for searching and filtering technology business intelligence data of FIG. 7; in this case, an interface offering detailed industry data filters.

FIG. 13 shows a non-limiting example of an interface for searching and filtering business intelligence data; in this case, an interface for searching by contact name and filtering based on contact parameters such as: contact level, contact departments, location, specialized rankings, company size, company industry, and technology.

FIG. 14 shows a non-limiting example of the interface for searching and filtering contact business intelligence data of FIG. 13; in this case, an interface offering detailed contact level data filters.

FIG. 15 shows a non-limiting example of the interface for searching and filtering contact business intelligence data of FIG. 13; in this case, an interface offering detailed contact department data filters.

FIG. 16 shows a non-limiting example of the interface for searching and filtering contact business intelligence data of FIG. 13; in this case, an interface offering detailed location data filters.

FIG. 17 shows a non-limiting example of the interface for searching and filtering contact business intelligence data of FIG. 13; in this case, an interface offering detailed specialized ranking data filters.

FIG. 18 shows a non-limiting example of the interface for searching and filtering contact business intelligence data of FIG. 13; in this case, an interface offering detailed company size data filters.

FIG. 19 shows a non-limiting example of the interface for searching and filtering contact business intelligence data of FIG. 13; in this case, an interface offering detailed company industry data filters.

FIG. 20 shows a non-limiting example of the interface for searching and filtering contact business intelligence data of FIG. 13; in this case, an interface offering detailed technology data filters.

FIG. 21 shows a non-limiting example of an interface for searching and filtering business intelligence data; in this case, an interface for searching by company name and filtering based on company parameters such as: company location, specialized rankings, company size, company industry, and technology.

FIG. 22 shows a non-limiting example of the interface for searching and filtering company business intelligence data of FIG. 21; in this case, an interface offering detailed company location data filters.

FIG. 23 shows a non-limiting example of the interface for searching and filtering company business intelligence data of FIG. 21; in this case, an interface offering detailed specialized ranking data filters.

FIG. 24 shows a non-limiting example of the interface for searching and filtering company business intelligence data of FIG. 21; in this case, an interface offering detailed company size data filters.

FIG. 25 shows a non-limiting example of the interface for searching and filtering company business intelligence data of FIG. 21; in this case, an interface offering detailed company industry data filters.

FIG. 26 shows a non-limiting example of the interface for searching and filtering company business intelligence data of FIG. 21; in this case, an interface offering detailed technology data filters.

### DETAILED DESCRIPTION OF THE INVENTION

Traditional sources of BI and CI fail to offer adequately up to date sales leads with actionable contact information and fail to associate data with particular products in product categories. Existing sources of BI and CI also fail to offer adequately actionable CI such as market share and market opportunity for products in a product category.

Described herein, in certain embodiments, are non-transitory computer-readable storage media encoded with a computer program including instructions executable by a processor to create a business intelligence application comprising: a software module configured to harvest data pertaining to products in a product category from one or more publicly available online resources; a software module configured to match the data to a business entity, the business entity an end user of at least one product in the product category; and a software module configured to transform the data into a business intelligence display, the display comprising: sales targets for a product in the product category, market share for a product in the product category, or market opportunity for a product in the product category.

Also described herein, in certain embodiments, are non-transitory computer-readable storage media encoded with a computer program including instructions executable by a processor to create a business intelligence application comprising: a software module configured to receive input indicating a product category, a product, and optionally, one or more additional sales parameters; a software module configured to harvest data pertaining to products in the product category from one or more publicly available online resources; a software module configured to perform keyword analysis on the data; a software module configured to match the data to a business entity, the business entity an end user of at least one product in the product category; and a software module configured to transform the data into a business intelligence display, the display comprising: sales targets for the product in the product category, market share for the product in the product category, or market opportunity for the product in the product category.

Also described herein, in certain embodiments, are computer-implemented systems comprising: a digital processing device comprising an operating system configured to perform executable instructions and a memory device; a computer program including instructions executable by the digital processing device to create a business intelligence application comprising: a software module configured to harvest data pertaining to products in a product category from one or more publicly available online resources; a software module configured to match the data to a business entity, the business entity an end user of at least one product in the product category; and a software module configured to transform the data into a business intelligence display, the display comprising: sales targets for a product in the product category, market share for a product in the product category, or market opportunity for a product in the product category.

Also described herein, in certain embodiments, are computer-implemented systems comprising: a digital processing device comprising an operating system configured to perform executable instructions and a memory device; a computer program including instructions executable by the digital processing device to create a business intelligence application comprising: a software module configured to receive input indicating a product category, a product, and optionally, one or more additional sales parameters; a software module configured to harvest data pertaining to products in the product category from one or more publicly available online resources; a software module configured to perform keyword analysis on the data; a software module configured to match the data to a business entity, the business entity an end user of at least one product in the product category; and a software module configured to transform the data into a business intelligence display, the display comprising: sales targets for the product in the product category, market share for the product in the product category, or market opportunity for the product in the product category.

Also described herein, in certain embodiments, are computer-implemented methods comprising the steps of: harvesting, by a computer processor, data pertaining to one or more products in a product category from one or more publicly available online resources; performing, by the computer processor, keyword analysis on the data; matching, by the computer processor, the data to a business entity, the business entity an end user of at least one product in the product category; and transforming, by the computer processor, the data into a business intelligence display, the display comprising: sales targets for the product in the product category, market share for the product in the product category, or market opportunity for the product in the product category.

Also described herein, in certain embodiments, are computer-implemented methods comprising the steps of: harvesting data pertaining to one or more products in a product category from one or more publicly available online resources, the harvesting performed by a computer processor configured to perform data scraping; performing, by the computer processor, keyword analysis on the data; matching, by the computer processor, the data to a business entity, the business entity an end user of at least one product in the product category; and filtering the data, by the computer processor, to exclude data not associated with an end user of at least one product in the product category; whereby the method produces sales target contact information, the sales target associated with a business entity that is an end user of at least one product in the product category.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Business Intelligence Application

In some embodiments, the systems, software, media, and methods described herein include a business intelligence application, or use of the same. In some embodiments, the business intelligence application is a software application. In some embodiments, the business intelligence application operates over a computer network. Many computer networks are suitable including, by way of non-limiting examples, intranets and the Internet. In further embodiments, the business intelligence application is a server application that provides services to remote clients on a software-as-a-service (SaaS) basis.

In some embodiments, the business intelligence application comprises one or more software modules. In various embodiments, the business intelligence application comprises, for example, 1, 2, 3, 4, 5, 6, 7, 8, 9, 10, 11, 12, 13, 14, 15, 16, 17, 18, 19, 20 or more software modules. Many types of software modules are useful in implementing a business intelligence application. For example, in some embodiments, the business intelligence application comprises a software module configured to receive input indicating a product category, a product, and optionally, one or more additional sales parameters. In some embodiments, the business intelligence application comprises a software module configured to harvest data pertaining to products in the product category from one or more publicly available online resources. In some embodiments, the business intelligence application comprises a software module configured to perform validation of the data. In some embodiments, the business intelligence application comprises a software module configured to perform keyword analysis on the data. In some embodiments, the business intelligence application comprises a software module configured to filter the data to exclude data not associated with an end user of at least one product in the product category. In some embodiments, the business intelligence application comprises a software module configured to match the data to a business entity, the business entity an end user of at least one product in the product category. In some embodiments, the business intelligence application comprises a software module configured to transform the data into a business intelligence display, the display comprising: sales targets for the product in the product category, market share for the product in the product category, or market opportunity for the product in the product category.

The systems, software, media, and methods described herein, in particular embodiments are particularly useful for tracking changes and trends in market share, measuring effectiveness of marketing efforts, determining products used by sales and marketing targets, and conducting sales and marketing efforts design to replace a competing product in a competitive space.

### Products and Product Categories

In some embodiments, the systems, software, media, and methods described herein include a software module configured to receive input indicating a product and a product category, or use of the same. In some embodiments, the systems, software, media, and methods described herein include a software module configured to harvest data pertaining to products in the product category. In some embodiments, the systems, software, media, and methods described herein include a software module configured to filter the data to exclude data not associated with an end user of at least one product in the product category and a software module configured to match the data to a business entity, the business entity an end user of at least one product in the product category. In some embodiments, the systems, software, media, and methods described herein include a software module configured to transform the data into a business intelligence display, the display comprising: sales targets for the product in the product category, market share for the product in the product category, or market opportunity for the product in the product category.

Suitable products include those sold B2B through sales and marketing representatives. Many product categories are suitable including, by way of non-limiting examples, vehicles, transportation equipment, instruments, tools, industrial equipment, industrial supplies, manufacturing equipment, manufacturing supplies, office supplies, shipping materials, uniforms and apparel, training services, employee benefits, software, and hardware. In the case of software, suitable product categories include, by way of non-limiting examples, data warehousing, business intelligence, sales and marketing, engineering, research and development, ERP, storage, databases, database management, business process, enterprise integration, quality control, IT infrastructure, networking, security, communications, content management, finance, legal compliance, server management, data center management, and human resources.

### Harvesting and Processing Data

In some embodiments, the systems, software, media, and methods described herein include a software module configured to harvest data, or use of the same. Many types of data are suitably harvested. In some embodiments, the data includes product data. In some embodiments, the data includes product category data. In some embodiments, the data includes competitive data. In further embodiments, the competitive data includes, by way of non-limiting examples, company name, technology name, technology type, product categories used, products used, company location (e.g., continents, countries, states, etc.), company size (e.g., employees, revenue, etc.), industry, rankings and awards, and the like. In some embodiments, the data includes contact information. In further embodiments, the contact information includes, by way of non-limiting examples, contact level, contact department, name, organization, title, email address, phone number, fax number, location, mailing address, supervisor, tenure, company size, company rankings and awards, technology, and the like.

In some embodiments, the data is harvested from one or more proprietary resources, such as private a database. In further embodiments, the data is harvested from one or more proprietary online resources (e.g., accessible via the web, etc.). In some embodiments, the data is harvested from one or more publicly available resources. In some embodiments, the data is harvested from one or more publicly available online resources (e.g., accessible via the web, etc.). Many publicly available online resources are suitable for harvesting data including, by way of non-limiting examples, web search results, technology discussion boards, technology user forums, company web sites, job/employment web sites, social networks, and professional networks. In certain embodiments, suitable job/employment web sites include, for example, indeed, Simply Hired, Monster, Dice, Career Builder, Linkup, Smart Brief, Linkedin, The Ladders, Mashable Jobs, and the like. In certain embodiments, suitable social/professional networks include, for example, Badoo, Bebo, Blogster, Buzzfeed, CafeMom, Classmates.com, Delicious, Digg, Diglo, Facebook, FARK, Flixster, Flickr, Fotolog, Foursquare, Friendfeed, Friends Reunited, Friendster, Google+, Habbo, LinkedIn, Livejournal, Meetup, Mixi, Mylife, Myspace, MyYearbook, Netlog, Ning, Pingsta, Pinterest, Plaxo, Reddit, Slashdot, SoundCloud, Stumbleupon, Tagged, Tumblr, Tweetmeme, Twitter, Yammer, Yelp, and the like. In some embodiments, the data is harvested from resources identified based on the relevant industry, product category, product, technology, location, and the like.

In some embodiments, a software module configured to harvest data optionally accesses one resource. In other embodiments, a software module configured to harvest data optionally accesses a plurality of resources. In various embodiments, data is harvested from, by way of non-limiting examples, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more resources. In further embodiments, data is harvested from, by way of non-limiting examples, 20, 30, 40, 50, 60, 70, 80, 90, 100 or more resources, including increments therein. In further embodiments, data is harvested from, by way of non-limiting examples, 100, 200, 300, 400, 500, 600, 700, 800, 900, 1000 or more resources, including increments therein. In some embodiments, data is harvested from, by way of non-limiting examples, at least 2 resources, at least 3 resources, at least 4 resources, at least 5 resources, at least 6 resources, at least 7 resources, at least 8 resources, at least 9 resources, or at least 10 resources. In some embodiments, data is harvested from, by way of non-limiting examples, about 1 to about 50 resources, about 1 to about 40 resources, about 1 to about 30 resources, about 1 to about 20 resources, about 1 to about 10 resources.

In light of the disclosure provided herein, the skilled artisan will recognize that harvesting a large volume of data from a wide range and large number of resources potentially increases the scale and reach of the systems, software, media, and methods described herein. In some embodiments, the data is harvested from a number of resources identified based on the relevant industry, product category, product, technology, location, and the like.

In some embodiments, the software module configured to harvest data utilizes one or more automated software agents (e.g., web bots, Internet bots, web robots, etc.) to harvest data. In further embodiments, the one or more automated software agents are software applications that run automated tasks over the Internet. In some embodiments, the one or more automated software agents (e.g., web bots, Internet bots, web robots, etc.) conduct web scraping (e.g., web spidering, web harvesting, web data extraction, etc.). In further embodiments, the web scraping comprises extraction of information from websites through use of an automated script to fetch, analyze and store information from web servers. In still further embodiments, the web scraping is conducted by implementing low-level Hypertext Transfer Protocol (HTTP) or by embedding a web browser in the software module.

In some embodiments, the software module configured to harvest data extracts data from the web in general. In other embodiments, the software module configured to harvest data extracts data from specific URL's or targets specific types of data. In further embodiments, the software module configured to harvest data accepts input from a software module configured to receive input indicating a product category, a product, and optionally, one or more additional sales parameters.

In some embodiments, a software module configured to harvest data aggregates, stores, and retrieves harvested data. In some embodiments, the software module configured to harvest data retrieves unstructured data from the web, in some cases in HTML format for the purposes of transforming the data into structured data optionally stored and analyzed in a central local database or spreadsheet. Many procedures for web scraping are suitable. In various embodiments, suitable web scraping procedures utilize a variety of selection policies including, by way of non-limiting embodiments, focused crawling, path-ascending crawling, and the like.

In some embodiments, keyword analysis is performed on harvested data. In some embodiments, the systems, software, media, and methods described herein include a software module configured to perform keyword analysis on the data. In some embodiments, keyword analysis is performed to identify relevant data. In further embodiments, keyword analysis is performed to identify data associated with a particular industry, technology, product category, product, business entity, individual, or the like. Many types of keyword analysis are suitable. In some embodiments, keyword analysis includes building and maintaining a database of keywords selected to identify relevant web content. In further embodiments, keyword analysis includes checking for the presence of one or more keywords. In some embodiments, keyword analysis includes measuring the frequency of one or more keywords. In some embodiments, keyword analysis includes measuring the proximity of two or more keywords. In certain embodiments, keyword analysis includes assigning a score, rank, or rating.

In some embodiments, harvested data is validated. In some embodiments, validation of harvested data is automated. In further embodiments, the systems, software, media, and methods described herein include a software module configured to validate the data. In some embodiments, validation of harvested data includes accessing the relevancy of harvested data. In some embodiments, validation of harvested data includes accessing the integrity or authenticity of harvested data. In other embodiments, validation of harvested data is performed manually by one or more human participants. In yet other embodiments, validation of harvested data is performed by both automated processes and manually by human participants.

### Matching Data to Businesses

In some embodiments, the systems, software, media, and methods described herein include a software module configured to match harvested data to a business entity. In further embodiments, a software module configured to match harvested data to a business entity matches the data to a business entity, which is an end user of at least one product in a product category or interest. In some embodiments, matching harvested data to a business entity includes performing keyword analysis to identify a business entity. In some embodiments, matching harvested data to a business entity includes analysis of one or more URLs, links, email addresses, or names associated with the data. In some embodiments, a software module configured to match harvested data to a business entity utilizes fuzzy logic to account for different ways of referring to a particular business entity (e.g., short names, alternative names, acronyms, nicknames, etc.).

In some embodiments, the systems, software, media, and methods described herein include a software module configured to filter (e.g., exclude, remove, etc.) harvested data to exclude data not associated with an identifiable business entity. In further embodiments, the a software module configured to filter (e.g., exclude, remove, etc.) harvested data to exclude data not associated not associated with an identifiable business entity filters data not associated with an end user of at least one product in the product category. For example, in some embodiments, data harvested based on presence and proximity of relevant keywords is optionally excluded because it is not matched to a business entity which is an end user of a particular product.

### Transforming Data

In some embodiments, the systems, software, media, and methods described herein include a software module configured to transform harvested data into a business intelligence display, or use of the same. In some embodiments, a business intelligence display includes sales targets (including contact information) for one or more products in a product category. In some embodiments, a business intelligence display includes market share for one or more products in a product category. In some embodiments, a business intelligence display includes market opportunity one or more products in a product category.

Referring to FIG. 1, in a particular embodiment, a business intelligence display includes a dashboard summarizing BI and CI produced by the systems, software, media, and methods described herein and pertaining to the account of a particular user. In this embodiment, the display includes a pie chart of market share for products in the user's product category, a table of the number of companies included in the BI for each region of the U.S., a bar graph of the number of relevant technologies and relevant contacts for each region of the U.S., and a line graph of the growth of stored data for the relevant technologies over time.

In some embodiments, the elements of a business intelligence display are interactive, providing more detailed information upon interaction. In some embodiments, a user interacts with a business intelligence display using a pointing device including, by way of non-limiting examples, a mouse, trackball, trackpad, joystick, pen, or stylus. In further embodiments, a user interacts via a pointing device by actions including, by way of non-limiting examples, click, click and hold, double click, right click, drag and drop, and the like. In some embodiments, a user interacts with a business intelligence display using a touch screen display or multi-touch screen display. In further embodiments, a user interacts via a touch screen or multi-touch screen by gestures including, by way of non-limiting examples, tap (e.g., touch), double tap, tap (e.g., touch) and hold, swipe, drag, pinch, reverse pinch, draw, and highlight. In some embodiments, a user interacts with a business intelligence display using a keyboard, keypad, or alternative text input device, by keystroke, combination of keystrokes, or sequence of keystrokes.

Referring to FIG. 2, in a particular embodiment, a business intelligence display includes a market share pie chart from the display of FIG. 1. In this embodiment, the pie chart includes detailed information (e.g., competitor, number of customers, and percent market share) available upon interaction with each element of the chart.

Referring to FIG. 3, in a particular embodiment, a business intelligence display includes a bar graph of the number of relevant technologies and relevant contacts for each region of the U.S. from the display of FIG. 1. In this embodiment, the bar graph includes detailed information (e.g., number of relevant technologies) available upon interaction with each element of the graph.

Referring to FIG. 4, in a particular embodiment, a business intelligence display includes a technology growth line graph from the display of FIG. 1. In this embodiment, the line graph includes detailed information (e.g., date, technology, and number) available upon interaction with each element of the graph.

In some embodiments, the steps of the methods described herein are iteratively repeated over time and the data stored such that changes in the data are quantifiable and included in a business intelligence display. In some embodiments, the systems and software described herein are continuously executing the functions described herein to harvest, process, transform, and store data over time such that changes in the data are quantifiable and included in a business intelligence display. Accordingly, in certain embodiments, a business intelligence display includes data that indicates trend over time.

Many time intervals are suitable for iterative repetition of the methods and execution of functions described herein. In various embodiments, the methods are repeated (or the software run) at least every 1 second, 2 seconds, 3 seconds, 4 seconds, 5 seconds, 10 seconds, 20 seconds, 30 seconds, 40 second, 50 seconds, or 60 seconds, including increments therein. In further various embodiments, the methods are repeated (or the software run) at least every 1 minute, 2 minutes, 3 minutes, 4 minutes, 5 minutes, 10 minutes, 20 minutes, 30 minutes, 40 minutes, 50 minutes, 60 or minutes, including increments therein. In further various embodiments, the methods are repeated (or the software run) at least every 1 day, 2 days, 3 days, 4 days, 5 days, 6 days, or 7 days, including increments therein. In further various embodiments, the methods are repeated (or the software run) at least every 1 week, 2 weeks, 3 weeks, or 4 weeks, including increments therein. In further various embodiments, the methods are repeated (or the software run) at least every 1 month, 2 months, 3 months, 4 months, 5 months, 6 months, 7 months, 8 months, 9 months, 10 months 11 months, or 12 months, including increments therein. In some embodiments, the methods and processes are run continuously or substantially continuously.

Referring to FIG. 5, in a particular embodiment, a business intelligence display includes a dashboard summarizing BI and CI produced by the systems, software, media, and methods described herein and pertaining to the account of a particular user. In this embodiment, the display includes trended data. Further in this embodiment, the display includes market share, trends of competitor products over time, market share per industry over time, and market share per region over time.

Referring to FIG. 6, in a particular embodiment, a business intelligence display includes a dashboard summarizing BI and CI produced by the systems, software, media, and methods described herein and pertaining to the account of a particular user. In this embodiment, a business intelligence display includes a display of trended business intelligence for individual competitor products in a product category including tools for filtering data. Further in this embodiment, available filters are based on time, technology, and competitor dimensions (e.g., region, revenue, industry, and number of employees).

In some embodiments, the BI and CI produced by the systems, software, media, and methods described herein sales targets (including contact information). In further embodiments, a business intelligence display includes sales targets (including contact information) pertaining to the account of a particular user. In various embodiments, the sales targets include, by way of non-limiting examples, users (or potential users) of products in the relevant product category, users (or potential users) of the relevant products, users (or potential users) of competitive products, and the like. In further embodiments, a business intelligence display includes sales targets (including contact information) accessible via a GUI that provides tools for searching, sorting, and filtering the data. In further embodiments, searches are optionally constructed around parameters involving technology parameters, contact parameters, company parameters, and combinations thereof.

Referring to FIG. 7, in a particular embodiment, a business intelligence display includes an interface for searching and filtering business intelligence data. In this embodiment, the interface provides tools for constructing searches based on technology name and other technology parameters such as: technology type, company location, specialized rankings, company size, and industry. Further in this embodiment, constructed searches are optionally saved for viewing and execution at a later date.

Referring to FIG. 8, in a further embodiment, the interface for searching and filtering technology business intelligence data of FIG. 7 offers tools for conducting detailed searches based on technology type. In this embodiment, technology type parameters include parent technology category, technology category, and technology.

Referring to FIG. 9, in a further embodiment, the interface for searching and filtering technology business intelligence data of FIG. 7 offers tools for conducting detailed searches based on company location. In this embodiment, company location parameters include continents, countries, and states.

Referring to FIG. 10, in a further embodiment, the interface for searching and filtering technology business intelligence data of FIG. 7 offers tools for conducting detailed searches based on specialized company rankings. In this embodiment, company rankings include inclusion in various indexes and lists (e.g., Forbes Global 2000, Forbes Private 500, Fortune 100, Fortune 500, Inc 500, Inc 5000, Red Herring 100 Global, Red Herring 100 North America, and S&P 500, etc.).

Referring to FIG. 11, in a further embodiment, the interface for searching and filtering technology business intelligence data of FIG. 7 offers tools for conducting detailed searches based on company size. In this embodiment, company size parameters include number of employees and revenue.

Referring to FIG. 12, in a further embodiment, the interface for searching and filtering technology business intelligence data of FIG. 7 offers tools for conducting detailed searches based on industry. In this embodiment, industry parameters include specific industries and sub-industries.

Referring to FIG. 13, in a particular embodiment, a business intelligence display includes an interface for searching and filtering business intelligence data. In this embodiment, the interface provides tools for constructing searches based on contact name and other contact parameters such as: contact level, contact departments, contact location, specialized rankings, company size, company industry, and technology. Further in this embodiment, constructed searches are optionally saved for viewing and execution at a later date.

Referring to FIG. 14, in a further embodiment, the interface for searching and filtering contact business intelligence data of FIG. 13 offers tools for conducting detailed searches based on contact level within an organization. In this embodiment, contact level parameters include C level, Executive VP or GM level, VP level, Director level, Manager level, Individual Contributor, and other.

Referring to FIG. 15, in a further embodiment, the interface for searching and filtering contact business intelligence data of FIG. 13 offers tools for conducting detailed searches based on contact department within an organization. In this embodiment, contact level parameters include first, second, and third level departments.

Referring to FIG. 16, in a further embodiment, the interface for searching and filtering contact business intelligence data of FIG. 13 offers tools for conducting detailed searches based on contact location. In this embodiment, contact location parameters include continents, countries, and states.

Referring to FIG. 17, in a further embodiment, the interface for searching and filtering contact business intelligence data of FIG. 13 offers tools for conducting detailed searches based on specialized company rankings. In this embodiment, company rankings include inclusion in various indexes and lists (e.g., Forbes Global 2000, Forbes Private 500, Fortune 100, Fortune 500, Inc 500, Inc 5000, Red Herring 100 Global, Red Herring 100 North America, and S&P 500, etc.).

Referring to FIG. 18, in a further embodiment, the interface for searching and filtering contact business intelligence data of FIG. 13 offers tools for conducting detailed searches based on company size. In this embodiment, company size parameters include number of employees and revenue.

Referring to FIG. 19, in a further embodiment, the interface for searching and filtering contact business intelligence data of FIG. 13 offers tools for conducting detailed searches based on industry. In this embodiment, industry parameters include specific industries and sub-industries.

Referring to FIG. 20, in a further embodiment, the interface for searching and filtering contact business intelligence data of FIG. 13 offers tools for conducting detailed searches based on technology. In this embodiment, technology parameters include parent technology category, technology category, and technology.

Referring to FIG. 21, in a particular embodiment, a business intelligence display includes an interface for searching and filtering business intelligence data. In this embodiment, the interface provides tools for constructing searches based on company name and other company parameters such as: company location, specialized rankings, company size, company industry, and technology. Further in this embodiment, constructed searches are optionally saved for viewing and execution at a later date.

Referring to FIG. 22, in a further embodiment, the interface for searching and filtering company business intelligence data of FIG. 21 offers tools for conducting detailed searches based on company location. In this embodiment, company location parameters include continents, countries, and states.

Referring to FIG. 23, in a further embodiment, the interface for searching and filtering company business intelligence data of FIG. 21 offers tools for conducting detailed searches based on specialized company rankings. In this embodiment, company rankings include inclusion in various indexes and lists (e.g., Forbes Global 2000, Forbes Private 500, Fortune 100, Fortune 500, Inc 500, Inc 5000, Red Herring 100 Global, Red Herring 100 North America, and S&P 500, etc.).

Referring to FIG. 24, in a further embodiment, the interface for searching and filtering company business intelligence data of FIG. 21 offers tools for conducting detailed searches based on company size. In this embodiment, company size parameters include number of employees and revenue.

Referring to FIG. 25, in a further embodiment, the interface for searching and filtering company business intelligence data of FIG. 21 offers tools for conducting detailed searches based on industry. In this embodiment, industry parameters include specific industries and sub-industries.

Referring to FIG. 26, in a further embodiment, the interface for searching and filtering company business intelligence data of FIG. 21 offers tools for conducting detailed searches based on technology. In this embodiment, technology parameters include parent technology category, technology category, and technology.

### Media Portal

In some embodiments, the systems, software, media, and methods described herein include a software module configured to provide a media portal, or use of the same. In some embodiments, the media portal is a web-based portal accessible via the web and available to search engines. In further embodiments, a media portal includes a plurality of publications available for viewing and/or download.

In some embodiments, the publication are organized by subject matter. In further embodiments, subject matter of the publications includes a product category, one or more products, or a technology. In further embodiments, the publications include, by way of non-limiting examples, white papers, research papers, reports, reviews, news articles, and the like.

In some embodiments, a media portal includes allows download or viewing of the publications upon provision of contact information. In further embodiments, a media portal is utilized to harvest BI and CI. In still further embodiments, a user viewing or downloading a publication on a particular product category, products, or technology is identified by the systems, software, media, and methods described herein as a potential sales lead in connection with the particular product category, products, or technology. In some embodiments, the contact information is harvested as BI and/or CI in connection with the subject matter of the requested publication.

### Digital Processing Device

In some embodiments, the systems, software, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX°, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the systems, software, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, software, media, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight°, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Software Modules

In some embodiments, the systems, software, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, software, media, and methods disclosed herein include one or more databases, or use of the same. In view of the disclosure provided herein, those of skill in the art will recognize that many databases are suitable for storage and retrieval of business intelligence information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Data Harvesting and Transformation

A business intelligence (BI) application provider operates a web application under a software-as-a-service (SaaS) model. The application continually harvests data from web-based sources. The data pertains to enterprise software products in the information technology product category. The application utilizes a host of autonomous web bots to access the data. Five web-based data sources are accessed to gather information pertaining to the software products. The data sources include a technology discussion board, a technology user forum, a technology provider web site, a job web site, and a professional network. Each source contains information about at least one enterprise software product in the product category.

Once harvested, the application performs keyword analysis on the data. The keyword analysis includes identifying pre-determined keywords and determining word proximity associations between keywords. One important function of the keyword analysis is to match each identified piece of information to a business entity that is an end user of at least one of the enterprise software products of interest. The application further performs validation of the data. A first round of validation is automatic, excluding data that falls outside of pre-determined parameters. A second round of validation is manual, performed by technicians via visual inspection of the information. Finally, the analyzed and validated data is filtered to exclude data not associated with an end user of at least one product in the product category.

The database of BI is transformed into a BI display for the benefit of users of the service. The BI display provides a list of companies which have the technology installed, the relevant contacts at those companies, and also the contacts associated with the product at the company. Each contact has individual contact information including, in many cases, physical address, email address, and phone number.

### Example 2

### User Experience and Use of a Business Intelligence Display

A sales manager user of a BI web application configures a new account. The user enters information pertaining to their product category of interest and products of interest. In this case the user's sales focus is on enterprise security software solutions in the information technology space. The user also enters information pertaining to their preferred sales targets including industry, target size, target region, target revenue, or target current product.

The BI web application presents a BI display customized for the benefit of the sale manager. The display provides technology install base information (e.g., companies which use a particular technology), the type of contacts available at those companies, and individual contacts associated with the technology. Each contact includes individual contact information and is searchable and/or filterable by industry, technology, company, company location, ranking, company size, and contact.

The BI display also includes a visual representation of trended market share for the sale manager's product in the product category as well as trended market opportunity in a product category.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. Non-transitory computer-readable storage media encoded with a computer program including instructions executable by a processor to create a business intelligence application for generating business to business sales contacts for enterprise products comprising:
a. a software module configured to harvest data pertaining to enterprise products in an enterprise product category from one or more publicly available online resources via one or more automated software agents, wherein the one or more publicly available online resources comprise one or more of a technology discussion board, a technology user forum, a company web site, a job web site, a social network, or a professional network;
b. a software module configured to match the data to a business entity, the business entity an end user of at least one of the enterprise products in the enterprise product category; and
c. a software module configured to transform the data into a business intelligence display, the display comprising: contact information for individual sales targets associated with the business entity, the display further comprising market share for a product in the product category or market opportunity for a product in the product category.

2. Non-transitory computer-readable storage media encoded with a computer program including instructions executable by a processor to create a business intelligence application comprising:
a. a software module configured to receive input indicating an enterprise product category, an enterprise product, and optionally, one or more additional sales parameters;
b. a software module configured to harvest data pertaining to enterprise products in the enterprise product category from one or more publicly available online resources via one or more automated software agents, wherein the one or more publicly available online resources comprise one or more of a technology discussion board, a technology user forum, a company web site, a job web site, a social network, or a professional network;
c. a software module configured to perform keyword analysis on the data;
d. a software module configured to match the data to a business entity, the business entity an end user of at least one of the enterprise products in the enterprise product category; and
e. a software module configured to transform the data into a business intelligence display, the display comprising: contact information for individual sales targets associated with the business entity, the display further comprising market share for the product in the product category or market opportunity for the product in the product category.

3. The media of claim 2, wherein the one or more additional sales parameters comprise: industry, target size, target region, target revenue, or target current product.

4. The media of claim 2, wherein the data is harvested from about 2 to about 20 publicly available online resources.

5. The media of claim 2, wherein the one or more publicly available online resources comprise a web search result.

6. The media of claim 2, wherein the one or more automated software agents are web bots.

7. The media of claim 2, wherein the keyword analysis comprises identifying keywords and determining word proximity associations.

8. The media of claim 2, wherein the application further comprises a software module configured to perform validation of the data.

9. The media of claim 2, wherein the application further comprises a software module configured to filter the data to exclude data not associated with an end user of at least one product in the product category.

10. (canceled)

11. The media of claim 2, wherein the sales targets are searchable or filterable by one or more of: industry, technology, company, company location, ranking, company size, and contact.

12. The media of claim 2, wherein the business intelligence display comprises a visual representation of market share or market opportunity in a product category.

13. The media of claim 2, wherein the application executes over time and stores data to produce a trended business intelligence display.

14. The media of claim 2, wherein the application is in communication with a media portal, the media portal offering product information for download, the media portal capturing and communicating individual contact information.

15. A computer-implemented system comprising:
a. a digital processing device comprising an operating system configured to perform executable instructions and a memory device;
b. a computer program including instructions executable by the digital processing device to create a business intelligence application comprising:
i. a software module configured to harvest data pertaining to enterprise products in an enterprise product category from one or more publicly available online resources via one or more automated software agents, wherein the one or more publicly available online resources comprise one or more of a technology discussion board, a technology user forum, a company web site, a job web site, a social network, or a professional network;
ii. a software module configured to match the data to a business entity, the business entity an end user of at least one of the enterprise products in the enterprise product category; and
iii. a software module configured to transform the data into a business intelligence display, the display comprising: contact information for individual sales targets associated with the business entity, the display further comprising market share for a product in the product category or market opportunity for a product in the product category.

16. The system of claim 15, wherein the data is harvested from about 2 to about 20 publicly available online resources.

17. The system of claim 15, wherein the one or more publicly available online resources comprise a web search result.

18. The system of claim 15, wherein the one or more automated software agents are web bots.

19. The system of claim 15, wherein the application further comprises a software module configured to perform validation of the data.

20. (canceled)

21. The system of claim 15, wherein the business intelligence display comprises a visual representation of market share or market opportunity in a product category.

22. The system of claim 15, wherein the application executes over time and stores data to produce a trended business intelligence display.

23. A computer-implemented method comprising the steps of:
a. harvesting, by a computer processor, data pertaining to one or more enterprise products in an enterprise product category from one or more publicly available online resources via one or more automated software agents, wherein the one or more publicly available online resources comprise one or more of a technology discussion board, a technology user forum, a company web site, a job web site, a social network, or a professional network;
b. performing, by the computer processor, keyword analysis on the data;
c. matching, by the computer processor, the data to a business entity, the business entity an end user of at least one of the enterprise products in the enterprise product category; and
d. transforming, by the computer processor, the data into a business intelligence display, the display comprising: contact information for individual sales targets associated with the business entity, the display further comprising market share for a product in the product category or market opportunity for a product in the product category.

24. The method of claim 23, wherein the data is harvested from about 2 to about 20 publicly available online resources.

25. The method of claim 23, wherein the one or more publicly available online resources comprise a web search result.

26. The method of claim 23, wherein the software module configured to one or more automated software agents are web bots.

27. The method of claim 23, further comprising the step of performing validation of the data by the computer processor.

28. (canceled)

29. The method of claim 23, wherein the business intelligence display comprises a visual representation of market share or market opportunity in a product category.

30. The method of claim 23, wherein the method is performed iteratively over time and the data stored to produce a trended business intelligence display.
